(19) United States
(12) Patent Application Publication
(10) Pub. No.: US 2017/0001304 A1
(43) Pub. Date: Jan. 5, 2017

(54) ACTUATOR

(71) Applicant: DENSO WAVE INCORPORATED, Chita-gun, Aichi-pref. (JP)

(72) Inventor: Yusuke KATO, Chita-gun (JP)

(73) Assignee: DENSO WAVE INCORPORATED, Chita-gun, Aichi-pref. (JP)

(21) Appl. No.: 15/105,317

(22) PCT Filed: Jan. 13, 2015
(86) PCT No.: PCT/JP2015/000111

§ 371 Date: Jun. 16, 2016

(30) Foreign Application Priority Data
Jan. 31, 2014 (JP) 2014-016320

(51) Int. Cl. B25J 9/10; G01D 5/14; H02K 7/14; H02K 7/116; H02K 11/215; H02K 11/33; G01D 5/04; H02K 7/00

(52) U.S. Cl. CPC B25J 9/102; G01D 5/04; G01D 5/145; H02K 7/003; H02K 7/116; H02K 11/215; H02K 11/33; H02K 7/14

(57) ABSTRACT

A plurality of intermediate shafts, which are placed between an input shaft and an output shaft, respectively includes a large diameter gear and a small diameter gear. The large diameter gear of each intermediate shaft is meshed with a corresponding one of an input gear of the input shaft or the small diameter gear of another one of the intermediate shafts located on the input shaft side. The small diameter gear of each intermediate shaft is meshed with a corresponding one of an output shaft of the output shaft or the large diameter gear of another one of the intermediate shafts located on the output shaft side.

### CROSS REFERENCE TO RELATED APPLICATION

The present application is based on and incorporates herein by reference Japanese Patent Application No. 2014-16320 filed on Jan. 31, 2014.

### TECHNICAL FIELD

The present disclosure relates to an actuator.

### BACKGROUND ART

As recited in, for example, the Patent Literature 1, a device, which has three geared shafts, i.e., a sensing-subject shaft, a first shaft and a second shaft, is known as a rotational angle sensing device used in, for example, an actuator. In this device, a gear, which is meshed with a gear of the sensing-subject shaft, and a gear, which is meshed with a gear of the second shaft, are provided to the first shaft. A rotational angle of the sensing-subject shaft is computed based on a combination of rotational angles respectively sensed at the first shaft and the second shaft, which are other than the sensing-subject shaft.

### CITATION LIST

### Patent Literature

### Patent Literature 1: JP2004-61428A

### SUMMARY OF THE INVENTION

However, in the rotational angle sensing device recited in the Patent Literature 1, when a diameter of the shaft, the rotational angle of which is sensed, is increased, a size of the rotational angle sensing device is disadvantageously increased. Therefore, a technique, which reduces a size of the rotational angle sensing device, has been demanded. Furthermore, cost reduction of the rotational angle sensing device, ease of manufacturing of the rotational angle sensing device, and improvement of design freedom have been demanded.

The present disclosure is made to address at least one of the above objectives and can be implemented in the following manner.

(1) According to one aspect of the present disclosure, there is provided an actuator to be used at a joint of a robot. The actuator includes: an electric motor; an input shaft member that is rotated about an axis of the input shaft member by rotation of the electric motor; an input gear that is fixed to and is rotated integrally with the input shaft member; an output shaft member that is rotated about an axis of the output shaft member and has a through-hole, which is formed to extend in an axial direction of the output shaft member and receives an electric line used to control the robot; an output gear that is fixed to and is rotated integrally with the output shaft member; at least two intermediate shaft members, each of which is rotated about an axis of the intermediate shaft member; at least two large diameter gears, each of which is fixed to and is rotated integrally with a corresponding one of the at least two intermediate shaft members; at least two small diameter gears, each of which is fixed to and is rotated integrally with the corresponding one of the at least two intermediate shaft members, wherein a diameter of each of the at least two small diameter gears is smaller than a diameter of the large diameter gear, which is fixed to the corresponding one of the at least two intermediate shaft members; and two angle sensing devices, which respectively sense rotational angles of two sensing-subject shaft members among the input shaft member and the at least two intermediate shaft members, wherein: the large diameter gear of each of the at least two intermediate shaft members is meshed with a corresponding one of: the input gear; and the small diameter gear that is fixed to another one of the at least two intermediate shaft members, which is located on a side where the input shaft member is placed; and the small diameter gear of each of the at least two intermediate shaft members is meshed with a corresponding one of: the output gear; and the large diameter gear that is fixed to another one of the at least two intermediate shaft members, which is located on a side where the output shaft member is placed. According to the actuator of the above aspect, the rotational angle of the output shaft member can be computed by sensing the rotational angles of other shaft members, which are other than the output shaft member. Since a large angle sensing device for sensing the rotational angle of the output shaft member, which has the through-hole and a large diameter, is not required, a size of the actuator can be reduced. Furthermore, in a case where another shaft member, which has a large diameter, is present besides the output shaft member, the rotational angle of the output shaft member can be computed by sensing the rotational angles of the other shaft members, which are other than the shaft member that has the large diameter. Therefore, the size of the actuator can be further reduced. Furthermore, the rotational angle of the output shaft member is computed through use of the angle sensing devices. Therefore, the rotational angle of the output shaft member can be computed throughout the wide range of equal to or larger than 360 degrees, by using the angle sensing devices of the simple structure, which can only sense an absolute angle of the shaft member. Thereby, the costs of the actuator can be limited.

(2) In the actuator of the above aspect, the large diameter gear fixed to one of the two sensing-subject shaft members may be meshed with the small diameter gear fixed to another one of the two sensing-subject shaft members; and a number of teeth of the large diameter gear fixed to the one of the two sensing-subject shaft members and a number of teeth of the small diameter gear fixed to the another one of the two sensing-subject shaft members may be mutually prime to each other. According to the actuator of this aspect, even in a case where the rotational angle of the one of the two sensing-subject shaft members is zero degrees upon rotation of the one of the two sensing-subject shaft members by 360 degrees, the rotational angle of the another one of the two sensing-subject shaft members is sensed as a corresponding different angle that is different from an angle of the another one of the two sensing-subject shaft members, which is sensed before the 360 degree rotation of the one of the two sensing-subject shaft members. Therefore, the rotational angle of the output shaft member can be computed throughout the wide range, which is larger than 360 degrees, based on the combination of the rotational angle of the one of the sensing-subject shaft members and the rotational angle of the another one of the sensing-subject shaft members.

(3) The actuator of the above aspect may further include a control board, which has a control unit that controls the electric motor, wherein each of the two angle sensing devices may include: a first sensing device that is installed to a corresponding one of the two sensing-subject shaft members; and a second sensing device that is installed to the control board; the control board may be placed at a location where central axes of the two sensing-subject shaft members intersect with the control board; and the first sensing device of each of the two angle sensing devices may be axially placed between the control board and the small diameter gear fixed to the corresponding one of the two sensing-subject shaft members. The actuator of this aspect is used at the joint of the robot and has a difficulty of its size reduction. The angle sensing devices are placed in a limited narrow space, and thereby it is difficult to install the angle sensing devices in an inside of the actuator. However, according to the actuator of this aspect, the control unit and the second sensing devices are integrated at the control board. Therefore, the second sensing devices can be handled as an intermediate size component. Thus, when the actuator of this aspect is used in a small robot, the assembling work of the small robot can be eased. Furthermore, the actuator has the structure of that the control board is axially opposed to the two sensing-subject shaft members, so that it is possible to reduce the size of the actuator while maintaining the accuracy of the actuator to a level that can withstand the practical use of the actuator. Furthermore, a manufacturing process of the control unit and the second sensing devices can be integrated, so that the manufacturing costs of the actuator can be limited. Furthermore, since the control unit and the portions of the second sensing devices are integrated, the size of the actuator can be further reduced, and the manufacturing of the actuator can be eased.

(4) In the actuator of the above aspect, each of the two angle sensing devices may be a magnetic rotational angle sensor. According to the actuator of this aspect, the inexpensive angle sensing devices, which sense the rotational angle of less than 360 degrees, are used without using an expensive sensor, which can sense multiple rotations, i.e., can sense a rotational angle of equal to or larger than 360 degrees. Therefore, the costs of the actuator can be further limited.

(5) The actuator of the above aspect may further include a control board, which has a control unit that controls the electric motor, wherein: each of the two angle sensing devices may include: a magnet that is installed to a corresponding one of the two sensing-subject shaft members; and a detector that is installed to the control board and detects a magnetic flux generated from the magnet; a portion of a housing, which rotatably supports the at least two intermediate shaft members and the output shaft member, may be interposed between the magnet and the detector of each of the two angle sensing devices; and the portion of the housing may be made of a non-magnetic material. In the actuator of this aspect, a portion of the housing serves as a shield that limits scattering of the gear oil, which lubricates the large diameter gears and the small diameter gears fixed to the intermediate shaft members and the output gear fixed to the output shaft member, onto the detectors of the two angle sensing devices, so that failure of the detectors caused by the scattering of the gear oil can be limited.

(6) According to another aspect the present disclosure, there is provided another actuator to be used at the joint of the robot. The actuator includes an electric motor; an input shaft member that is rotated about an axis of the input shaft member by rotation of the electric motor; an input gear that is fixed to and is rotated integrally with the input shaft member; an output shaft member that is rotated about an axis of the output shaft member and has a through-hole, which is formed to extend in an axial direction of the output shaft member and receives an electric line used to control the robot; an output gear that is fixed to and is rotated integrally with the output shaft member; an intermediate shaft member that is rotated about an axis of the intermediate shaft member; a large diameter gear that is fixed to and is rotated integrally with the intermediate shaft member; a small diameter gear that is fixed to and is rotated integrally with the intermediate shaft member, wherein a diameter of the small diameter gear is smaller than a diameter of the large diameter gear, which is fixed to the intermediate shaft member; and two angle sensing devices, which respectively sense a rotational angle of the input shaft member and a rotational angle of the intermediate shaft member, wherein: the large diameter gear, which is fixed to the intermediate shaft member, is meshed with the input gear; and the small diameter gear, which is fixed to the intermediate shaft member, is meshed with the output gear. With the actuator of this aspect, advantages, which are similar to the advantages discussed at the above section (1), can be achieved.

All of the constituent components of each of the above aspects are not absolutely necessary. In order to address some or all of the above objectives or to achieve some or all of the advantages recited in the specification, some of the constituent components of each of the above aspects may be modified, deleted or replaced with another component, or some feature(s) of these constituent components may be deleted. Furthermore, in order to address some or all of the above objectives or to achieve some or all of the advantages recited in the specification, some or all of the technical features of one of the above aspects may be combined with some or all of the technical features of another one or more of the above aspects.

For example, one embodiment of the present disclosure may be implemented as a device that includes some or all of an input shaft member, an input gear, an output shaft member, an output gear, at least two intermediate shaft members (or at least one intermediate shaft member), large diameter gear(s), small diameter gear(s), and two angle sensing devices. Specifically, this device may have or may not have the input shaft member. Also, the device may have or may not have the input gear. Furthermore, the device may have or may not have the output shaft member. Also, the device may have or may not have the output gear. Additionally, the device may have or may not have the at least two intermediate shaft members (or the at least one intermediate shaft member). Also, the device may have or may not have the large diameter gear(s). Also, the device may have or may not have the small diameter gears. Also, the device may have or may not have the angle sensing devices. The input shaft member may be rotated about an axis thereof by rotation of the electric motor. The input gear may be fixed to the input shaft member and may be rotated integrally with the input shaft member. The output shaft member may be rotated about an axis thereof and may have a through-hole that extends in an axial direction and receives an electric line(s) used for controlling the robot. The output gear may be fixed to the output shaft member and may be rotated integrally with the output shaft member. The at least two intermediate shaft members (or the at least one intermediate shaft member) may be rotated about, for example, its axis. The large diameter gears may be respectively fixed to the at least two intermediate shaft members (or the at least one intermediate shaft member) and may be respectively rotated integrally with the at least two intermediate shaft members (or the at least one intermediate shaft member). Also, each of the large diameter gears may be meshed with one of the input gear or the small diameter gear fixed to another one of the intermediate shaft members located on the input shaft member side. The small diameter gears may be respectively fixed to the at least two intermediate shaft members (or the at least one intermediate shaft member) and may be respectively rotated integrally with the at least two intermediate shaft members (or the at least one intermediate shaft member). Furthermore, a diameter of each of the small diameter gears may be smaller than a diameter of the large diameter gear fixed to the common intermediate shaft member. Also, each of the small diameter gears may be meshed with one of the output gear or the large diameter gear fixed to another one of the intermediate shaft members located on the output shaft member side. The angle sensing devices may respectively sense the rotational angles of two shaft members among, for example, the input shaft member and the at least two intermediate shaft members (or the at least one intermediate shaft member). The device may be implemented as the actuator or may be implemented as another type of device, which is other than the actuator. According to this aspect, it is possible to address at least one of various objectives, such as improvement of operability of the device, simplification of the device, integration of the device, improvement of convenience of the user of the device. Some or all of the technical features of the respective aspects of the actuator described above may be applied to this device.

The present disclosure may be implemented in various other aspects other than the actuator itself. For example, the present disclosure may be implemented in a robot having the actuator, a control method of the robot having the actuator, or a robot system having the actuator.

### BRIEF DESCRIPTION OF DRAWINGS

FIG. 1 is a descriptive view showing a schematic structure of a robot according to an embodiment of the present disclosure.

FIG. 2 is a descriptive view showing a schematic structure of an actuator of the embodiment.

FIG. 3 is a descriptive view showing a schematic structure of an actuator of a modification.

### DESCRIPTION OF EMBODIMENTS

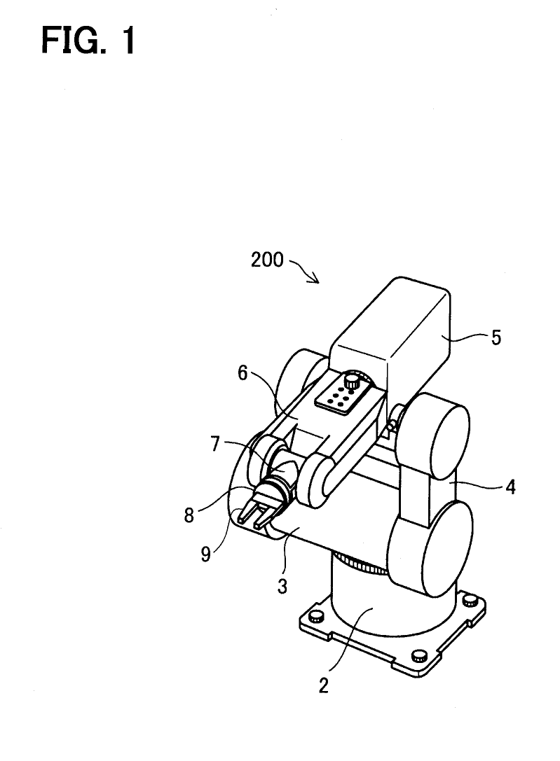

FIG. 1 is a descriptive view showing a schematic structure of a robot 200 according to an embodiment of the present disclosure. The robot 200 of the present embodiment is an industrial six-axis vertical articulated robot.

The robot 200 includes: a base 2 that is fixed to a horizontal surface at an installation location (site), such as a factory; a shoulder 3 that is supported by the base 2 in a manner that enables rotation of the shoulder 3 about a first axis, which extends in a vertical direction; a lower arm 4 that has a lower end portion supported by the shoulder 3 in a manner that enables rotation of the lower arm 4 about a second axis, which extends in a horizontal direction; a rear upper arm 5 that is supported by a distal end portion of the lower arm 4 in a manner that enables rotation of the rear upper arm 5 about a third axis, which extends in the horizontal direction; a front upper arm 6 that is supported by the rear upper arm 5 in a manner that enables rotation of the front upper arm 6 about a fourth axis, which is perpendicular to the third axis; a wrist 7 that is supported by a distal end portion of the front upper arm 6 in a manner that enables rotation of the wrist 7 about a fifth axis, which is perpendicular to the fourth axis; and a flange 8 that is supported by the wrist 7 in a manner that enables rotation of the flange 8 about a sixth axis, which is perpendicular to the fifth axis. A hand 9, which serves as an end effector and holds, for example, a work, is detachably installed to the flange 8. As the end effector, another device (e.g., a camera for visual inspection), which is other than the hand 9, is installable to the flange 8. An actuator is placed at each of the first to sixth axes. The robot 200 performs various tasks when the respective actuators are controlled to change, for example, a position of the lower arm 4.

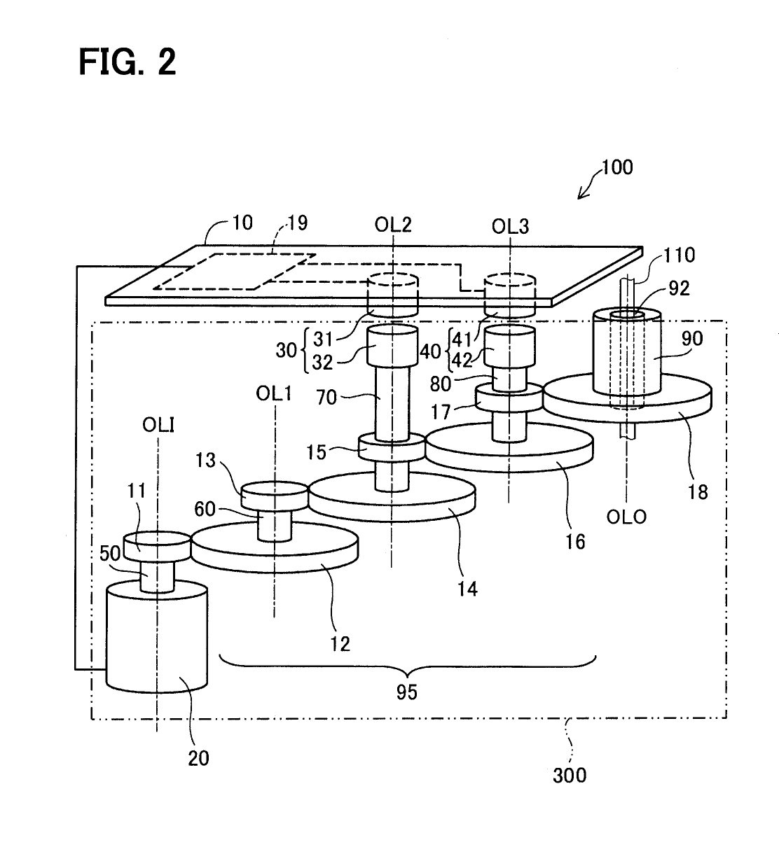

FIG. 2 is a descriptive view showing a schematic structure of the actuator 100 of the present embodiment. The actuator 100 is a device that is used at a rotary joint of the robot 200 and includes a speed reducing device 95 and an electric motor 20. As shown in FIG. 2, the actuator 100 includes a control board 10, the electric motor 20, an input shaft 50 connected to the electric motor 20, an output shaft 90, the speed reducing device 95, a first angle sensor 30, and a second angle sensor 40. As shown in FIG. 2, the electric motor 20, the input shaft 50, a portion of the output shaft 90 (a portion other than an output end portion of the output shaft 90, which is an upper end portion of the output shaft 90 in FIG. 2), the speed reducing device 95, a first magnet 32 of the first angle sensor 30, and a second magnet 42 of the second angle sensor 40 are received in an inside of a housing 300 made of a non-magnetic material (e.g., aluminum or resin). The output end portion of the output shaft 90 projects to an outside from the housing 300. The speed reducing device 95 includes a first intermediate shaft 60, a second intermediate shaft 70 and a third intermediate shaft 80. The first intermediate shaft 60, the second intermediate shaft 70, the third intermediate shaft 80 and the output shaft 90 are rotatably supported by the housing 300 through undepicted bearings.

The control board 10 includes a control unit 19 for executing supply of an electric power as well as transmission and reception of signals. The control unit 19 is connected to the electric motor 20, the first angle sensor 30 and the second angle sensor 40. The control unit 19 controls the electric power supplied to the electric motor 20 to rotate a rotor installed in the electric motor 20 and thereby controls a rotational speed and a rotational angle of the output shaft 90 that is rotated through the rotation of the rotor of the electric motor 20 transmitted to the output shaft 90. The control unit 19 obtains a rotational angle of the second intermediate shaft 70 and a rotational angle of the third intermediate shaft 80, which are respectively sensed with the first angle sensor 30 and the second angle sensor 40 described later, so that the control unit 19 executes feedback control for controlling, for example, the electric power supplied to the electric motor 20.

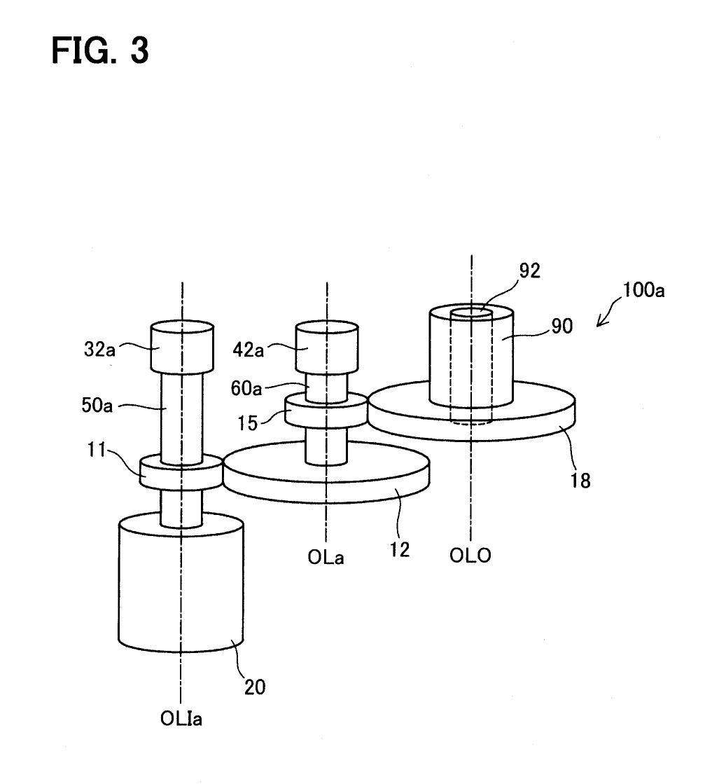

The rotor of the electric motor 20 is rotated by the electric power supplied from the control unit 19 together with the input shaft 50 connected thereto about an input shaft axis OLI. An input gear 11, which is rotated integrally with the input shaft 50 about the input shaft axis OLI, is fixed to the input shaft 50. The output shaft 90 is rotated about an output shaft axis OLO. The output shaft 90 is a shaft that has a through-hole 92, which extends through the output shaft 90 along the output shaft axis OLO. Various electric lines 110, which conduct, for example, the electric power for controlling the robot 200, are received through the through-hole 92 of the output shaft 90. Therefore, an outer diameter of the output shaft 90 is larger than outer diameters of the other shafts. An output gear 18, which is rotated integrally with the output shaft 90 about the output shaft axis OLO, is fixed to the output shaft 90. The output gear 18 is a gear that has a diameter, which is larger than a diameter of a third large diameter gear 16 described later. The input shaft 50 corresponds to an input shaft member of the present disclosure, and the output shaft 90 corresponds to an output shaft member of the present disclosure. Furthermore, although various gears, such as the input gear 11 and the output gear 18, are respectively shaped into circular disk forms for the sake of simplicity in FIGS. 2 and 3 described later, it should be noted that teeth are formed along an outer peripheral portion of each of these gears.

The first intermediate shaft 60 is rotated about a first intermediate shaft axis OL1. A first large diameter gear 12 and a first small diameter gear 13, which are rotated integrally with the first intermediate shaft 60 about the first intermediate shaft axis OL1, are fixed to the first intermediate shaft 60. The first large diameter gear 12 is a gear that has a diameter, which is larger than a diameter of the first small diameter gear 13 and a diameter of the input gear 11. The first large diameter gear 12 and the input gear 11 are meshed with each other, so that the first intermediate shaft 60 is rotated in response to rotation of the input shaft 50.

The second intermediate shaft 70 is rotated about a second intermediate shaft axis OL2. A second large diameter gear 14 and a second small diameter gear 15, which are rotated integrally with the second intermediate shaft 70 about the second intermediate shaft axis OL2, are fixed to the second intermediate shaft 70. The second large diameter gear 14 is a gear that has a diameter, which is larger than a diameter of the second small diameter gear 15 and the diameter of the first small diameter gear 13. The second large diameter gear 14 and the first small diameter gear 13 are meshed with each other, so that the second intermediate shaft 70 is rotated in response to rotation of the first intermediate shaft 60. Furthermore, the second intermediate shaft 70 is placed at a location where the second intermediate shaft axis OL2 of the second intermediate shaft 70 intersects with the control board 10. The first magnet 32, which is a portion of the first angle sensor 30 described later, is installed to a portion of the second intermediate shaft 70, which is opposed to the control board 10 and is located between the second small diameter gear 15 and the control board 10.

The third intermediate shaft 80 is rotated about a third intermediate shaft axis OL3. A third large diameter gear 16 and a third small diameter gear 17, which are rotated integrally with the third intermediate shaft 80 about the third intermediate shaft axis OL3, are fixed to the third intermediate shaft 80. The third large diameter gear 16 is a gear that has a diameter, which is larger than a diameter of the third small diameter gear 17 and the diameter of the second small diameter gear 15. In the present embodiment, the number of teeth of the second small diameter gear 15 and the number of teeth of the third large diameter gear 16 are mutually prime to each other. The third large diameter gear 16 and the second small diameter gear 15 are meshed with each other, so that the third intermediate shaft 80 is rotated in response to rotation of the second intermediate shaft 70. Furthermore, the third intermediate shaft 80 is placed at a location where the third intermediate shaft axis OL3 of the third intermediate shaft 80 intersects with the control board 10. The second magnet 42, which is a portion of the second angle sensor 40 described later, is installed to a portion of the third intermediate shaft 80, which is opposed to the control board 10 and is located between the third small diameter gear 17 and the control board 10.

The output gear 18 and the third small diameter gear 17 are meshed with each other, so that the output shaft 90 is rotated in response to rotation of the third intermediate shaft 80. As described above, the rotation of the rotor of the electric motor 20 is transmitted to the output shaft 90 through the input shaft 50, the first intermediate shaft 60, the second intermediate shaft 70 and the third intermediate shaft 80 along a drive force transmission path. Furthermore, the diameter of the input side gear of each of these shafts is set to be large, so that the rotation of the electric motor 20 is transmitted to the output shaft 90 after reducing the rotational speed thereof through the input shaft 50, the first intermediate shaft 60, the second intermediate shaft 70 and the third intermediate shaft 80. The first intermediate shaft 60, the second intermediate shaft 70 and the third intermediate shaft 80 of the present embodiment correspond to at least two intermediate shaft members (or at least one intermediate shaft member) of the present disclosure. Furthermore, an input shaft member side gear of the present disclosure refers to a gear (e.g., the first large diameter gear 12 at the first intermediate shaft 60), which is one of the two gears fixed to the common shaft and is meshed with the gear fixed to the other shaft closer to the input shaft 50 in the drive force transmission path among the two gears fixed to the common shaft. Also, an output shaft member side gear of the present disclosure refers to a gear (e.g., the first small diameter gear 13 at the first intermediate shaft 60), which is another one of the two gears fixed to the common shaft and is meshed with the gear fixed to the other shaft closer to the output shaft 90 in the drive force transmission path among the two gears fixed to the common shaft. The closest two shaft members of the present disclosure do not refer to two shaft members, which are closest to each other in terms of a distance. Rather, the closest two shaft members of the present disclosure refer to two shaft members, which are closest to each other in terms of connection through the gears in the drive force transmission path. For example, the closest shaft, which is closest to the output shaft 90, is the third intermediate shaft 80, and the next closest shaft is the second intermediate shaft 70.

The first angle sensor 30 is a magnetic rotary encoder, which senses a rotational angle of the second intermediate shaft 70. The first angle sensor 30 senses an absolute angle of the second intermediate shaft 70. That is, the first angle sensor 30 senses the rotational angle of the second intermediate shaft 70 in a range that is equal to or larger than zero degrees and is smaller than 360 degrees. The first angle sensor 30 includes the first magnet 32, which is installed to the second intermediate shaft 70, and a first reading device (first detector) 31, which is formed in the control board 10. The first reading device 31 transmits a rotational angle of the second intermediate shaft 70 (as an electric signal), which is specified based on a change in an electric signal generated in response to rotation of the first magnet 32, to the control unit 19 of the control board 10 connected to the first reading device 31. Similar to the first angle sensor 30, the second angle sensor 40 is a magnetic rotary encoder that senses the rotational angle of the third intermediate shaft 80. The second angle sensor 40 includes the second magnet 42, which is installed to the third intermediate shaft 80, and a second reading device (second detector) 41, which is formed in the control board 10. In the present embodiment, each of the first reading device 31 and the second reading device 41 has a Hall IC. The first reading device 31 and the second reading device 41 respectively sense a change in a magnetic density at the first magnet 32 and a change in a magnetic density at the second magnet 42 and thereby respectively output a signal indicating the rotational angle of the second intermediate shaft 70 and a signal indicating the rotational angle of the third intermediate shaft 80 to the control unit 19. The second angle sensor 40 differs from the first angle sensor 30 only about the subject intermediate shaft to be sensed. Therefore, the description of the structure of the second angle sensor 40 will be omitted for the sake of simplicity.

As shown in FIG. 2, the control board 10, which has the control unit 19, the first reading device 31 and the second reading device 41, is placed at the outside of the housing 300 to avoid a failure caused by application of scattered gear oil, which is the lubricating oil for lubricating the gears 11-18 received in the housing 300. That is, the housing 300 serves as a shield, which limits scattering of the gear oil on the control board 10, which has the control unit 19, the first reading device 31 and the second reading device 41, to limit the failure of the devices of the control board 10, which include the control unit 19, the first reading device 31 and the second reading device 41, caused by the scattering of the gear oil. The first reading device 31 and the second reading device 41 are respectively placed at locations axially opposed to the first magnet 32 and the second magnet 42 at the outside of the housing 300. Here, it is only required that a portion of the housing 300, which is located between the control board 10 and the magnets 32, 42, is made of a non-magnetic material, through which a magnetic flux of the magnets 32, 42 can penetrate, and thereby the entire housing 300 is not necessarily made of the non-magnetic material. In a case where the first reading device 31 and the second reading device 41 respectively have a structure that can limit the failure caused by the scattering of the gear oil, the first reading device 31 and the second reading device 41 may be placed at a location adjacent to the first magnet 32 and the second magnet 42 in the inside of the housing 300. The first angle sensor 30 and the second angle sensor 40 respectively correspond to an angle sensing device of the present disclosure. The first magnet 32 and the second magnet 42 respectively correspond to a first sensing device (a movable device) of the present disclosure, and the first reading device 31 and the second reading device 41 respectively correspond to a second sensing device (a stationary device) of the present disclosure. Furthermore, the second intermediate shaft 70 and the third intermediate shaft 80 of the present embodiment respectively correspond to a sensing-subject shaft member of the present disclosure.

The control unit 19 computes a rotational angle of the output shaft 90 based on the rotational angle of the second intermediate shaft 70 and the rotational angle of the third intermediate shaft 80, which are respectively obtained through the first angle sensor 30 and the second angle sensor 40. The first angle sensor 30 and the second angle sensor 40 can only respectively sense the rotational angle of the second intermediate shaft 70 and the rotational angle of the third intermediate shaft 80 within a range of less than 360 degrees. However, since the number of the teeth of the second small diameter gear 15 and the number of the teeth of the third large diameter gear 16 are mutually prime to each other, the rotational angle of the output shaft 90 can be sensed throughout a wider range, which is equal to or larger than 360 degrees, by combining the rotational angle of the second intermediate shaft 70 and the rotational angle of the third intermediate shaft 80. For example, even in a case where the rotational angle of the third intermediate shaft 80, which is sensed with the second angle sensor 40, is zero degrees upon rotation of the third intermediate shaft 80 by 360 degrees, since the number of the teeth of the second small diameter gear 15 and the number of the teeth of the third large diameter gear 16 are mutually prime to each other, the first angle sensor 30 senses a corresponding different rotational angle every time the third intermediate shaft 80 is rotated by 360 degrees. Therefore, the control unit 19 can measure a rotation period of the third intermediate shaft 80 based on the rotational angle of the second intermediate shaft 70, which is sensed with the first angle sensor 30. Thus, the control unit 19 can measure the rotational angle of the output shaft 90 throughout the wider range.

As discussed above, in the actuator 100 of the present embodiment, the through-hole 92, which receives the various electric lines 110 for controlling the robot 200, is formed in the output shaft 90. Furthermore, the first angle sensor 30 senses the rotational angle of the second intermediate shaft 70, and the second angle sensor 40 senses the rotational angle of the third intermediate shaft 80. Since the actuator 100 of the present embodiment is used at the rotary joint of the robot 200, the through-hole 92, which receives the various electric lines 110, is formed in the output shaft 90, and thereby the diameter of the output shaft 90 tends to be increased. Therefore, in the case where the rotational angle of the output shaft 90 is directly measured, it is necessary to place the rotary encoder, which corresponds to the diameter of the output shaft 90. However, the actuator 100 of the present embodiment can sense the rotational angle of the output shaft 90 by sensing the rotational angles of the second intermediate shaft 70 and the third intermediate shaft 80, which are other than the output shaft 90. Therefore, it is not required to have a large rotary encoder for sensing the rotational angle of the output shaft 90, which has the through-hole 92 and thereby has the large diameter. Thus, the size of the actuator 100 can be reduced. Furthermore, in a case where there is another shaft, which has a large diameter, besides the output shaft 90, the rotational angle of the output shaft 90 can be computed by sensing the rotational angles of the other shafts, which are other than the shaft, which has the large diameter. Thereby, the size of the actuator 100 can be further reduced. Furthermore, the rotational angle of the output shaft 90 is computed through the two sensors, i.e., the first angle sensor 30 and the second angle sensor 40. Thereby, the rotational angle of the output shaft 90 can be computed throughout the wide range, which is equal to or larger than 360 degrees, by using the simple sensors, which can only sense the absolute angles of the second intermediate shaft 70 and the third intermediate shaft 80. Thereby, the costs of the actuator 100 can be limited.

Furthermore, in the actuator 100 of the present embodiment, the number of the intermediate shafts is equal to or larger than two, and the first angle sensor 30 and the second angle sensor 40 respectively sense the rotational angles of the second intermediate shaft 70 and the third intermediate shaft 80, which are other than the input shaft 50. Therefore, in the actuator 100 of the present embodiment, the rotation of the rotor of the electric motor 20 is transmitted to the output shaft 90 upon reducing the rotational speed thereof through the larger number of the intermediate shafts, so that it is possible to generate a larger torque at the output shaft 90.

Furthermore, in the actuator 100 of the present embodiment, the number of the teeth of the second small diameter gear 15 of the second intermediate shaft 70, which is closer to the input shaft 50 in comparison to the third intermediate shaft 80, and the number of the teeth of the third large diameter gear 16 of the third intermediate shaft 80, which is closer to the output shaft 90 in comparison to the second intermediate shaft 70, are set to be mutually prime to each other. Therefore, in the actuator 100 of the present embodiment, for example, even in the case where the rotational angle of the third intermediate shaft 80, which is sensed with the second angle sensor 40, is zero degrees upon rotation of the third intermediate shaft 80 by 360 degrees, the first angle sensor 30 senses the corresponding different rotational angle every time the third intermediate shaft 80 rotates by 360 degrees. Therefore, the rotational angle of the output shaft 90 can be computed throughout the wider range, which is larger than 360 degrees based on the combination of the rotational angle of the second intermediate shaft 70 and the rotational angle of the third intermediate shaft 80.

Furthermore, in the actuator 100 of the present embodiment, the first reading device 31 of the first angle sensor 30 and the second reading device 41 of the second angle sensor 40 are formed in the control board 10, which has the control unit 19 that controls the electric power supplied to the electric motor 20. Furthermore, the control board 10 is placed at the location where the second intermediate shaft axis OL2 of the second intermediate shaft 70 and the third intermediate shaft axis OL3 of the third intermediate shaft 80 intersect with the control board 10. The first magnet 32 of the first angle sensor 30 is placed between the second small diameter gear 15 of the second intermediate shaft 70 and the control board 10, and the second magnet 42 of the second angle sensor 40 is placed between the third small diameter gear 17 of the third intermediate shaft 80 and the control board 10. The actuator 100 of the present embodiment is used at the joint of the robot, so that it is difficult to reduce the size of the actuator 100. The first angle sensor 30 and the second angle sensor 40 are placed in the limited narrow space, so that it is difficult to install the first angle sensor 30 and the second angle sensor 40 in the inside of the actuator 100. With respect to this point, in the actuator 100 of the present embodiment, the control unit 19, the first reading device 31 and the second reading device 41 are integrated at the control board 10, so that the first reading device 31 and the second reading device 41 can be handled as an intermediate size component. Therefore, when the actuator 100 of the present embodiment is used in the small robot, the assembling work of the small robot can be eased. The control board 10 is constructed to axially oppose the second intermediate shaft axis OL2 and the third intermediate shaft axis OL3, so that it is possible to reduce the size of the actuator 100 while maintaining the accuracy of the actuator 100 to a level that can withstand the practical use of the actuator 100. Furthermore, a manufacturing process of forming the control unit 19, the first reading device 31 and the second reading device 41 in the control board 10 can be integrated, so that the manufacturing costs of the actuator 100 can be limited.

Furthermore, in the actuator 100 of the present embodiment, the first angle sensor 30 and the second angle sensor 40 are respectively formed as the magnetic rotary encoders, which respectively sense the rotational angles of the second intermediate shaft 70 and the third intermediate shaft 80 as the absolute angles. Therefore, in the actuator 100 of the present embodiment, the inexpensive sensors, which sense the rotational angle of less than 360 degrees, are used without using an expensive sensor, which can sense the multiple rotations, i.e., which can sense the rotational angle of equal to or larger than 360 degrees. Therefore, the costs of the actuator 100 can be further limited.

Furthermore, in the actuator 100 of the present embodiment, the rotational angle of the output shaft 90 is computed by sensing the rotational angles of the second intermediate shaft 70 and the third intermediate shaft 80, which are closest to the output shaft 90. Therefore, in the actuator 100 of the present embodiment, the rotational angle of the output shaft 90 can be more accurately computed in comparison to a case where the rotational angle of the output shaft 90 is sensed based on rotational angles of shafts, which are apart from the output shaft 90.

The present disclosure is not limited to the above embodiment and can be embodied in various ways within the principle of the present disclosure. For instance, the above embodiment may be modified as follows.

In the above embodiment, the rotation of the electric motor 20 is transmitted to the output shaft 90 through the three intermediate shafts. However, the number of the intermediate shafts is not limited to this number and may be changed to any other number. FIG. 3 is a descriptive view showing a schematic structure of an actuator 100a of a modification of the embodiment. In FIG. 3, the control board 10, the housing 300 and the electric lines 110, which are the same as those discussed in the above embodiment, are not depicted for the sake of simplicity. In the actuator 100a of this modification, a first intermediate shaft 60a is provided as a single intermediate shaft. Therefore, a second magnet 42a is placed at a portion of the first intermediate shaft 60a, which is opposed to the control board (not shown). Furthermore, a first magnet 32a is placed at a portion of an input shaft 50a, which is opposed to the control board. As described above, the number of the intermediate shaft(s) of the actuator 100a can be one. Furthermore, the number of the intermediate shafts may be two or may be equal to or larger than four. In FIG. 3, each of the input shaft 50a and the first intermediate shaft 60a corresponds to the sensing-subject shaft member of the present disclosure.

In the above embodiment, the rotational angles of the two shafts, which are closest to the output shaft 90 among the three intermediate shafts, are sensed. However, the two shafts, the rotational angles of which are sensed, are not necessarily the two closest shafts, which are closest to the output shaft 90. These two shafts, the rotational angles of which are sensed, may be changed to other ones. For example, in the actuator 100 of the above embodiment, the shafts, the rotational angles of which are sensed, may be the input shaft 50 and the third intermediate shaft 80, respectively. Furthermore, instead of sensing the rotational angles of the two shafts, the rotational angles of three or more shafts, which include the first intermediate shaft 60, the second intermediate shaft 70 and the third intermediate shaft 80, may be sensed.

In the above embodiment, the magnetic rotary encoders are used as the sensors, which sense the rotational angles of the second intermediate shaft 70 and the third intermediate shaft 80 as the absolute angles. However, the sensor(s), which senses the rotational angle of the shaft(s), is not limited to this type and may be modified to any other type. For example, an optical angle sensor(s) may be used. Also, different types of sensors may be used as the first angle sensor 30 and the second angle sensor 40, respectively. Furthermore, the sensor(s), which senses the rotational angle, is not limited to the above one, which senses the absolute angle, and the sensor(s), which senses the rotational angle, may be a sensor that can sense an angle of multiple rotations.

In the above embodiment, the first reading device 31 of the first angle sensor 30 and the second reading device 41 of the second angle sensor 40 are integrally formed on the board of the control board 10. However, the locations of the sensors, which sense the rotational angle, are not limited to this one and may be modified in various ways. For example, the first angle sensor 30 and the second angle sensor 40 may be installed to an angle sensor installation board, which is different from the board, to which the control unit 19 for controlling the electric motor 20 is installed.

The present disclosure is not limited to the above embodiment and the modifications thereof and may be implemented in various other constructions within the principle of the present disclosure. For example, the technical features of the embodiment and modifications thereof, which correspond to the technical features recited in the summary of the present disclosure, may be replaced with other one(s) or may be combined together for the purpose of addressing some or all of the objective of the present disclosure or for the purpose of achieving some or all of the above-described advantages. Furthermore, as long as the technical feature(s) is not described as an indispensable feature, such a feature may be deleted.

1. An actuator to be used at a joint of a robot, comprising:
an electric motor;
an input shaft member that is rotated about an axis of the input shaft member by rotation of the electric motor;
an input gear that is fixed to and is rotated integrally with the input shaft member;
an output shaft member that is rotated about an axis of the output shaft member and has a through-hole, which is formed to extend in an axial direction of the output shaft member and receives an electric line used to control the robot;
an output gear that is fixed to and is rotated integrally with the output shaft member;
at least two intermediate shaft members, each of which is rotated about an axis of the intermediate shaft member;
at least two large diameter gears, each of which is fixed to and is rotated integrally with a corresponding one of the at least two intermediate shaft members;
at least two small diameter gears, each of which is fixed to and is rotated integrally with the corresponding one of the at least two intermediate shaft members, wherein a diameter of each of the at least two small diameter gears is smaller than a diameter of the large diameter gear, which is fixed to the corresponding one of the at least two intermediate shaft members; and
two angle sensing devices, which respectively sense rotational angles of two sensing-subject shaft members among the input shaft member and the at least two intermediate shaft members, wherein:
the large diameter gear of each of the at least two intermediate shaft members is meshed with a corresponding one of:
the input gear; and
the small diameter gear that is fixed to another one of the at least two intermediate shaft members, which is located on a side where the input shaft member is placed; and
the small diameter gear of each of the at least two intermediate shaft members is meshed with a corresponding one of:
the output gear; and
the large diameter gear that is fixed to another one of the at least two intermediate shaft members, which is located on a side where the output shaft member is placed.

2. The actuator according to claim 1, wherein:
the large diameter gear fixed to one of the two sensing-subject shaft members is meshed with the small diameter gear fixed to another one of the two sensing-subject shaft members; and
a number of teeth of the large diameter gear fixed to the one of the two sensing-subject shaft members and a number of teeth of the small diameter gear fixed to the another one of the two sensing-subject shaft members are mutually prime to each other.

3. The actuator according to claim 1, further comprising a control board, which has a control unit that controls the electric motor, wherein:
each of the two angle sensing devices includes:
a first sensing device that is installed to a corresponding one of the two sensing-subject shaft members; and
a second sensing device that is installed to the control board;
the control board is placed at a location where central axes of the two sensing-subject shaft members intersect with the control board; and
the first sensing device of each of the two angle sensing devices is axially placed between the control board and the small diameter gear fixed to the corresponding one of the two sensing-subject shaft members.

4. The actuator according to claim 1, wherein each of the two angle sensing devices is a magnetic rotational angle sensor.

5. The actuator according to claim 1, further comprising a control board, which has a control unit that controls the electric motor, wherein:
each of the two angle sensing devices includes:
a magnet that is installed to a corresponding one of the two sensing-subject shaft members; and
a detector that is installed to the control board and detects a magnetic flux generated from the magnet;
a portion of a housing, which rotatably supports the at least two intermediate shaft members and the output shaft member is interposed between the magnet and the detector of each of the two angle sensing devices; and
the portion of the housing is made of a non-magnetic material.

6. An actuator to be used at a joint of a robot, comprising:
an electric motor;
an input shaft member that is rotated about an axis of the input shaft member by rotation of the electric motor;
an input gear that is fixed to and is rotated integrally with the input shaft member;
an output shaft member that is rotated about an axis of the output shaft member and has a through-hole, which is formed to extend in an axial direction of the output shaft member and receives an electric line used to control the robot;
an output gear that is fixed to and is rotated integrally with the output shaft member;
an intermediate shaft member that is rotated about an axis of the intermediate shaft member;
a large diameter gear that is fixed to and is rotated integrally with the intermediate shaft member;
a small diameter gear that is fixed to and is rotated integrally with the intermediate shaft member, wherein a diameter of the small diameter gear is smaller than a diameter of the large diameter gear, which is fixed to the intermediate shaft member; and
two angle sensing devices, which respectively sense a rotational angle of the input shaft member and a rotational angle of the intermediate shaft member, wherein:
the large diameter gear, which is fixed to the intermediate shaft member, is meshed with the input gear; and
the small diameter gear, which is fixed to the intermediate shaft member, is meshed with the output gear.
